(19) United States
(12) Patent Application Publication
(10) Pub. No.: US 2006/0041919 A1
(43) Pub. Date: Feb. 23, 2006

(54) Cable modem module device, cable modem device, and broadcast receiving device

(75) Inventors: Takeshi Tokunaga, Fukaya-shi (JP); Masami Oosawa, Kumagaya-shi (JP); Katsuya Kudo, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/205,322

(22) Filed: Aug. 17, 2005

(30) Foreign Application Priority Data
Aug. 19, 2004 (JP) 2004-239510

(51) Int. Cl. H04N 7/173; H04N 7/16

(52) U.S. Cl. 725/111; 725/116; 725/117; 725/147

(57) ABSTRACT

When a CATV signal supplied from a CATV center station is distributed to be lead out to a television tuner, an RF connector is provided on a circuit board of an analog signal processing section, and is configured to lead out the CATV signal by means of this RF connector. In this manner, a distribution output does not pass through a circuit board of a digital signal processing section. Therefore, a high quality signal can be distributed and outputted without being adversely affected by a digital signal.

### CROSS-REFERENCE TO RELATED APPLICATIONS

This application is based upon and claims the benefit of priority from prior Japanese Patent Application No. 2004-239510, filed Aug. 19, 2004, the entire contents of which are incorporated herein by reference.

### BACKGROUND OF THE INVENTION

1. Field of the Invention

The present invention relates to a cable modem module device which serves as an interface with a network using a cable television (CATV) line or the like, for example. In addition, the present invention relates to a cable modem device and a broadcast receiving device having the above-described cable modem module device incorporated therein.

2. Description of the Related Art

As is well known, a cable modem module device has been developed as an interface to connect an information terminal such as a user's own PC (personal computer) or the like to a network using a CATV line, for example.

This cable modem module device is connected to a CATV trunk line. The module device receives a CATV signal delivered from a CATV center station and leads out the received signal to an external television tuner. In addition, depending on a terminal such as a connected PC, the module device comprises a function for exchanging data to the CATV center station in a bi-directional manner.

From among the bi-directional data, data (downward signal) received by the cable modem module device is transmitted by utilizing an unused channel of the CATV. After the data has been received, as is the case with a general CATV signal, the received data is converted to an intermediate frequency, and then, the converted intermediate frequency is converted to a digital signal. The converted digital signal is applied to a demodulation process or the like. Thus, the downward signal is sent out as an analog signal having 60 MHz to 860 MHz, in general, from the CATV center station.

In addition, from among the bi-directional data, data (upward signal) transmitted from the cable modem module device to the CATV center station is sent out as a digital signal from a terminal such as a PC, and the digital signal is processed to be modulated. The modulated signal is then converted to an analog signal, and the converted analog signal is sent out as a signal having 5 MHz to 50 MHz to the CATV center station.

In order to achieve the above-described function, the cable modem module device has: a radio frequency (RF) coaxial connector connected to the CATV center station via a cable; and a diplexer which demultiplexes a signal supplied from the CATV center station to this connector and a signal sent out from the connector to the CATV center station.

In addition, the cable modem module device has: a distributor which divides a receiving signal demultiplexed by the diplexer; means for leading out one output of the distributor to the television tuner; and a frequency converter which converts the other output of the distributor as a frequency.

Further, the cable modem module device has a modulation and demodulation process and an interface section for converting an output of the frequency converter to a digital signal, digitally demodulating the digital signal, and sending the digitally demodulated signal to an external device such as a PC; and receiving information from the external device such as the PC, digitally modulating the information, analogously converting the digitally modulated information, and leading out the analogously modulated information to the diplexer.

Such a cable modem module device is targeted to be commercially available as a product alone, and may be constructed as a cable modem device or a broadcast receiving device, for example, by being incorporated in another device.

Thus, there is a demand for downsizing and reducing a cable modem module device in weight. However, there is a problem that, if a distance between input and output signal line channels is reduced in order to achieve downsizing, the input and output signals interfere with each other, making it difficult to maintain sufficient output signal quality.

In Jpn. Pat. Appln. KOKAI Publication No. 9-322142, there has been made a proposal that, in order to restrict an upstream data modulator circuit from adversely affecting a CATV signal, the upstream data modulator circuit and an up and down tuner are provided as modules in separate metal chassises, respectively, and further, a downward data demodulator circuit, the diplexer, and the distributor are provided as modules in such separate metal chassises.

In this proposal, the up and down tuner is provided as a module in a different metal chassis from those with the upstream data modulator circuit and the downstream data demodulator circuit. Thus, the up and down tuner can restrict a spurious effect of a digital signal.

However, in Jpn. Pat. Appln. KOKAI Publication No. 9-322142, each module is incorporated in a common circuit board. Thus, there is a danger that a spurious signal reaches the up and down tuner via a board wire, and the quality of a signal processed by the tuner is degraded.

The cable modem module device does not include the up and down tuner integrally. Thus, how well the quality of a signal to be supplied from the distributor to an external television tuner is established is important. However, the proposal of Jpn. Pat. Appln. KOKAI Publication No. 9-322142 has a problem that the device is affected by a digital signal via the circuit board.

As described above, conventionally, in the cable modem module device, a digital signal processing section and an analog signal processing section are made proximal to each other due to downsizing. Thus, there has been a problem that a spurious digital signal affects an analog signal.

### BRIEF SUMMARY OF THE INVENTION

According to one aspect of the present invention, there is provided a cable modem module device comprising: a first connector configured to be connected to a center station via a cable; an analog signal processing section which has a first circuit board having packaged thereon a circuit configuring a transmission/receiving section configured to receive a high frequency signal supplied from the center station via the first connector and send out the high frequency signal to the center station via the first connector, a distributor section configured to distribute the high frequency signal received by the transmission/receiving section, and a frequency converter section configured to convert a frequency of the high frequency signal distributed by the distributor section, respectively; a first shield section configured to shield the analog signal processing section in an electromagnetic manner; a digital signal processing section which has a second circuit board having packaged thereon a circuit configuring transmission/receiving processing sections configured to carry out transmission and receiving processing between an external device and a modulation/demodulation processing section configured to process a signal outputted from the analog signal processing section and output the processed signal to the external device via the transmission/receiving processing sections and process the signal from the external device and output the processed signal to the transmission/receiving section to be lead out from the first connector, respectively, and having packaged thereon the analog signal processing section; a second shield section configured to shield the digital signal processing section and the analog signal processing section shielded with the first shield section in an electromagnetic manner; and a second connector configured to be provided on the first circuit board without being covered with the first shield section and the second shield section in order to lead out the high frequency signal distributed by the distributor section to the outside.

According to another aspect of this invention, there is provided a cable modem device comprising a cable-modem module device of the type described above and a tuner section configured to receive a high-frequency signal from a second connector provided in the cable-modem module device.

According to still another aspect of this invention, there is provided a broadcast receiving device comprising a cable-modem module device of the type described above, a first section configured to receive a high-frequency signal from a second connector provided in the cable-modem module device, a third connector configured to be connected to a cable for transmitting a television broadcast signal, and a second tuner section configured to receive the television broadcast signal through the third connector.

### BRIEF DESCRIPTION OF THE SEVERAL VIEWS OF THE DRAWING

FIG. 1 is a view showing one embodiment of the present invention, provided to explain an outline of a CATV broadcast system;

FIG. 2 is a block diagram provided to explain a signal processor system of a cable modem device for use in the CATV broadcast system in the present embodiment;

FIG. 3 is a block diagram depicting a signal processing system of a cable modem module device for use in the cable modem device in the present embodiment;

FIG. 4 is an exploded perspective view provided to explain a specific structure of the cable modem module device in the present embodiment;

FIG. 5 is a plan view provided to explain a layout of circuit parts in the cable modem module device in the present embodiment;

FIG. 6 is a perspective view showing a state in which the cable modem module device in the present embodiment has been assembled;

FIG. 7 is an exploded perspective view provided to explain essential portions of the cable modem module device in the present embodiment;

FIG. 8 is a perspective view provided to explain a first modified example of the cable modem module device in the present embodiment;

FIG. 9 is a perspective view provided to explain a second modified example of the cable modem module device in the present embodiment;

FIG. 10 is a sectional side view provided to explain a third modified example of the cable modem module device in the present embodiment;

FIG. 11 is a block diagram provided to explain another use mode of the cable modem device in the present embodiment;

FIG. 12 is a perspective view provided to explain a configuration of the cable modem device in the present embodiment; and

FIG. 13 is a perspective view provided to explain a configuration of a broadcast receiving device in the present embodiment.

### DETAILED DESCRIPTION OF THE INVENTION

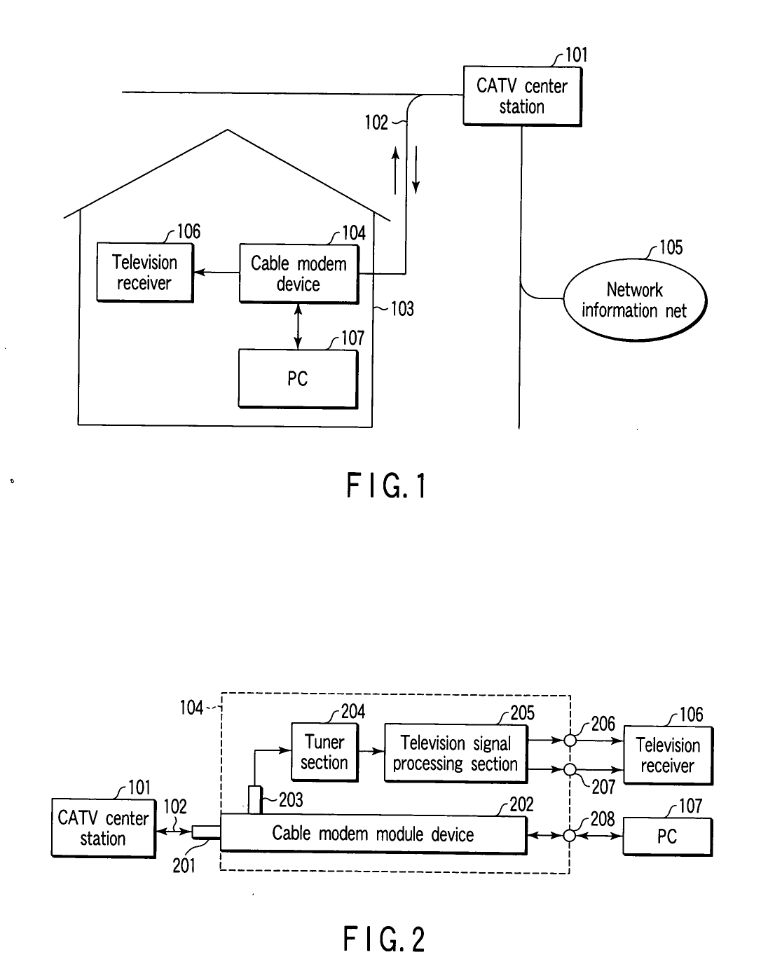

Hereinafter, one preferred embodiment of the present invention will be described in detail with reference to the accompanying drawings. FIG. 1 shows an outline of a CATV broadcast system explained in the present embodiment. In FIG. 1, reference numeral 101 denotes a CATV center station.

This CATV center station 101 is connected to a cable modem device 104 installed at each subscriber's home 103 via a CATV cable 102. In addition, the CATV center station 101 is connected to a variety of network information nets 105 such as the Internet, for example.

The cable modem device 104 has functions for carrying out a channel selecting process of a variety of programs distributed from the CATV center station 101 and a process for demodulating a variety of information such as a video image, a voice, and characters from the program selected as a channel. The video image, voice, and characters or the like demodulated by this cable modem device 104 are outputted to a television receiving device 106, and the outputted information is provided to be viewed by a user.

In addition, this cable modem device 104 can connect a PC 107. The PC 107 has a cable modem function for making data communication with a variety of network information nets 105 via the CATV center station 101.

FIG. 2 shows a signal processor system of the cable modem device 104 shown in FIG. 1. That is, an RF coaxial connector 201 to which the CATV cable 102 is to be connected is provided at a cable modem module device 202. The cable modem module device 202 includes a distributor which distributes a signal supplied from the CATV center station 101, and supplies the signal distributed by this distributor to a tuner section 204 via an RF connector 203. The tuner section 204 executes selection of a desired channel, and a signal of the selected channel is demodulated to a video image signal and a voice signal by means of a television signal processing section 205.

The video image signal and voice signal demodulated by means of the television signal processing section 205 is outputted to an external television receiver 106 or the like via a video image output terminal 206 and a voice output terminal 207, respectively, and the output signals are provided to be viewed by the user.

In addition, information on an access to the network information net 105, the information being outputted from the PC 107, is send out to the predetermined network information net 105 via an Ethernet (registered trademark) terminal 208; the cable modem module device 202; the RF coaxial connector 201; the CATV cable 102; and the CATV center station 101.

In addition, return information from the network information net 105 is supplied to the PC 107 via the CATV center station 101; the CATV cable 102; the RF coaxial connector 201; the cable modem module device 202; and the Ethernet (registered trademark) terminal 208.

Here, the cable modem module device 202 shown in FIG. 2 has a function for carrying out control of communication with the CATV center station 101; generation of an upward signal transmitted to the CATV center station 101; demodulation of a downward signal transmitted from the CATV center station 101; and control of data communication with an external device (PC 17 in this case) connected to the cable modem module device 202 or the like.

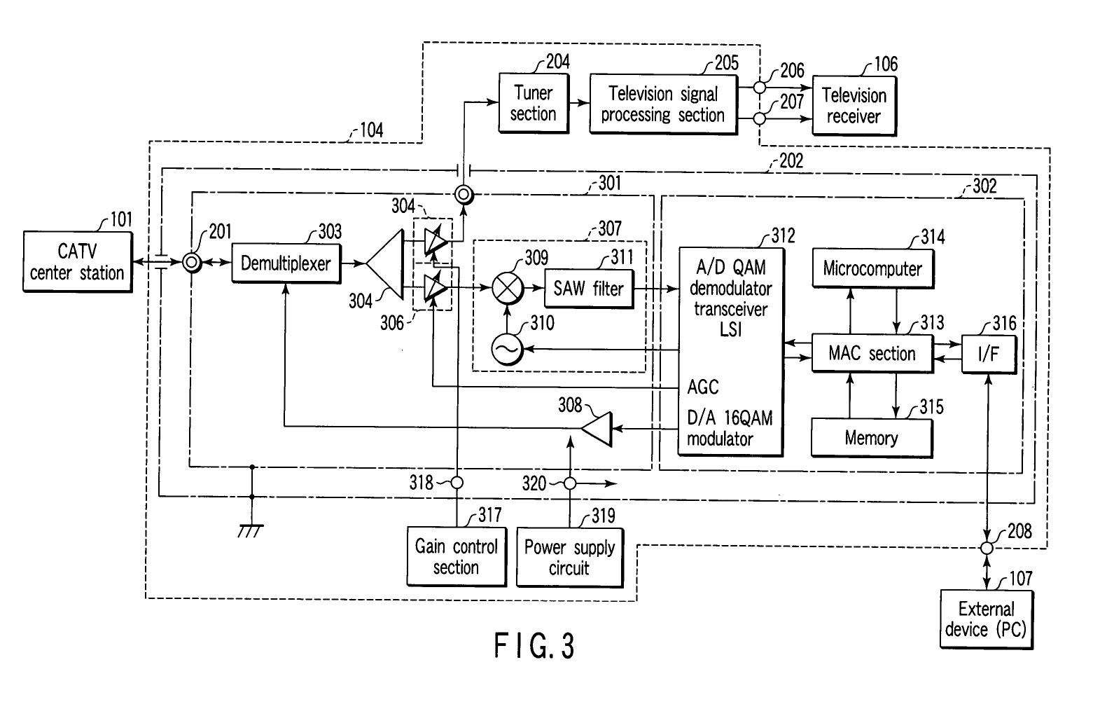

FIG. 3 shows a signal processing system of the cable modem module device 202. This cable modem module device 202 comprises: the CATV center station 101; an analog signal processing section 301 to handle a high frequency signal transmitted and received via the RF coaxial connector 201; and a digital signal processing section 302 which digitally processes a signal inputted and outputted to this analog signal processing section 301.

The analog signal processing section 301 has a diplexer 303 which comprises a demultiplexing function for receiving a signal from the CATV center station, the signal being supplied via the RF coaxial connector 201, and for sending out a signal to the CATV center station 101 via the RF coaxial connector 201.

Further, the analog signal processing section 301 has: a distributor 304 which distributes a signal from the CATV demultiplexed by the diplexer 303 into two sections; and variable gain amplifiers 305, 306 which adjust a gain of respective outputs of the distributor 304. Further, the analog signal processing section 301 has: the RF connector 203 which leads out an output of the variable gain amplifier 305 to the outside; a frequency converter section 307 which converts a frequency of an output of the variable gain amplifier 306; and an amplifier 308 which amplifies a signal outputted from the digital signal processing section 302 and leads out the amplified signal as an upward signal to the diplexer 303.

The frequency converter section 307 is composed of: a mixer 309 to which an output from the variable gain amplifier 306 is supplied; a local oscillator 310 which supplies a frequency conversion signal to the mixer 309; and a surface acoustic wave (SAW) filter 311 which samples and outputs a signal in a predetermined frequency band from an output of the mixer 309. This frequency converter section has a function for converting an RF signal to an intermediate frequency signal and outputting the converted signal.

The digital signal processing section 302 has a transceiver large-scale integrated circuit (LSI) 312 to which a signal from the SAW filter 311 is supplied. The transceiver LSI 312 has: an analog/digital (A/D) conversion processing function for converting the signal from the SAW filter 311 to a digital signal; and a function for applying a quadrature amplitude modulation (QAM) process to the converted digital signal.

Further, the transceiver LSI 312 has: a modulation processing function for 16 QAM-modulating upward data from a MAC section described later; a digital/analog (D/A) conversion processing function for converting the modulated digital signal to an analog signal; a function for controlling an oscillation frequency of the local oscillator 310 of the frequency converter section 307; and a function for controlling a gain of the variable gain amplifier 306. The D/A converted upward data is supplied to the diplexer 303 via the amplifier 308.

Further, the digital signal processing section 302 has a media access control (MAC) section 313 which receives a QAM-demodulated digital signal outputted from the transceiver LSI 312. This MAC section 313 has a function for making communication with the PC 107 as an external device. Thus, a microcomputer 314 and a memory 315 are connected to the MAC section 313, and further, an Ethernet (registered trademark) I/F (interface) 316 is connected to the MAC section.

The MAC section 313 leads out downward data to the PC 107 connected to the Ethernet (registered trademark) terminal 208 via the I/F 316. In addition, the upward data from the PC 107 is sent to the transceiver LSI 312 via the MAC section 312; modulation and analog conversion processes are applied to the data; and the processed data is led out to the diplexer 303 via the amplifier 308.

Further, the cable modem module device 202 comprises: a terminal 318 which receives a gain control signal from a gain control section 317 provided in the cable modem device 104 in order to control the variable gain amplifier 305; and a terminal 320 provided in the cable modem device 104, the terminal receiving an operating power supply voltage from a power supply circuit 319 which supplies operating power to each section of the cable modem module device 202, similarly.

In FIG. 3, a CATV signal from the CATV center station 101 is sent from the RF coaxial connector 201 to the distributor 304 via the diplexer 303, and the sent CATV signal is divided into two sections by means of the distributor 304. One of the two sections is lead out to the RF connector 203 via the variable gain amplifier 305, and is supplied to the tuner section 204.

The other output of the distributor 304 is supplied to the frequency converter section 307 via the variable gain amplifier 306. In the frequency converter section 307, an oscillation frequency of the local oscillator 310 is controlled under the control of the transceiver LSI 312. This converter section operates so as to lead out a signal of a predetermined frequency band from the mixer 309 via the SAW filter 311, and thus, has a function as a channel selector device. That is, the transceiver LSI 312 controls the local oscillator 310 so as to supply to the mixer 309 a local oscillation frequency signal which corresponds to a channel in which there exists a downward signal obtained by applying a QAM modulation to an output of the SAW filter 311.

The downward signal from the SAW filter 311 is processed by means of the digital signal processing section 302, and the processed signal is led out to the PC 107. An upward signal from the PC is supplied from the digital signal processing section 302 to the diplexer 303 via the amplifier 308, and the supplied signal is transmitted to the CATV center station 101 via the RF coaxial connector 201.

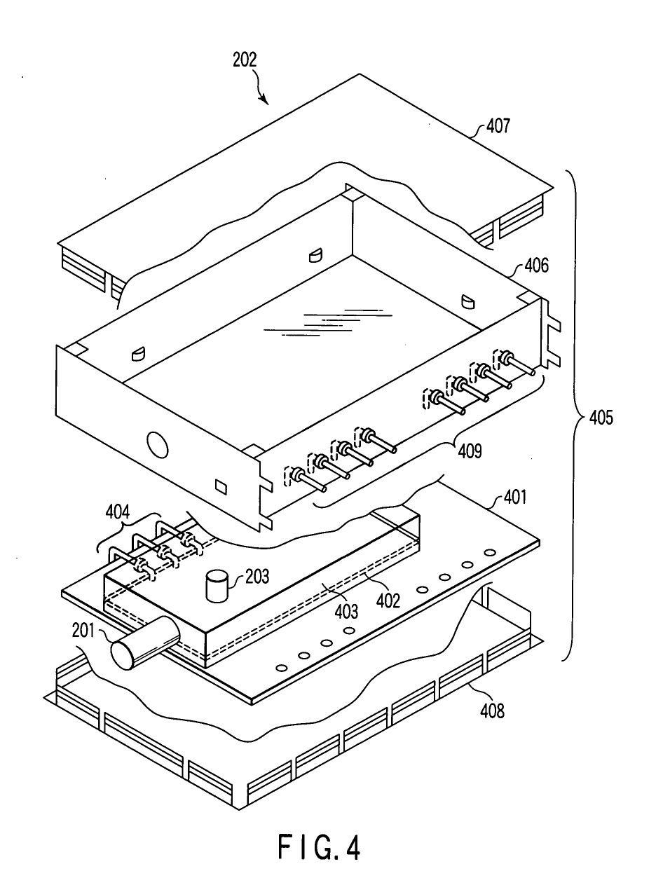

FIG. 4 is an exploded perspective view provided to explain a specific structure of the cable modem module device 202. In FIG. 4, reference numeral 401 denotes a circuit board. This circuit board 401 packages the analog signal processing section 301 and the digital signal processing section 302 shown in FIG. 3.

The analog signal processing section 301 comprises a circuit board 402. On this circuit board 402, the RF coaxial connector 201 is installed, and the analog signal processing section 301 is formed. Further, the RF connector 203 to lead out an RF signal to the tuner section 204 is installed.

Then, a configuration for housing the circuit board 402 in a shield case 403 formed of an element which has an effect of shielding unwanted irradiation of an electromagnetic wave such as a metal, for example, is provided so as to expose the RF coaxial connector 201 and the RF connector 203.

Further, the analog signal processing section 301 has analog signal input and output terminals 404, each of which is connected to the circuit board 402 at one end, and is protruded outwardly through the shield case 403 at the other end. In this manner, the analog signal processing section 301 is connected to the circuit board 401 at the other end of the terminals 404, thereby making connection with the digital signal processing section 302 packaged in the circuit board 401.

The cable modem module device 202 is configured by covering the periphery of the circuit board 401 on which the analog signal processing section 301 and the digital signal processing section 302 are packaged, with a substantially hexahedron shaped or analogously shaped shield case 405 having a function for shielding an electromagnetic wave from the outside.

The shield case 405 is formed of: a frame shaped metal case 406 which covers four faces at the periphery of the circuit board 401; a first cover 407 which covers one opening of this tetrahedron shaped metal case 406; and a second cover which covers the other opening of the metal case 406.

Here, the metal case 406 comprises: terminals 409 or the like for the purpose of electrical connection between an outside of the cable modem module device 202 and the digital signal processing section 302 on the circuit board 401 or supply of power from the outside of the cable modem module device 202 to a variety of circuits on the circuit board 401.

As these terminals 409, there are used terminals which are capable of inserting the metal case 406, as in a penetrating capacitor, for example, and which are capable of directly soldering with a circuit board (not shown) of the cable modem device 104; or alternatively, terminals capable of making connection via a connector having a simple structure. The terminals 409 each are connected to the circuit board 401 at one end, and are protruded outwardly to be inserted through the metal case 406 at the other end. Then, the terminals are provided to make connection with a circuit board of the cable modem device 104, although not shown.

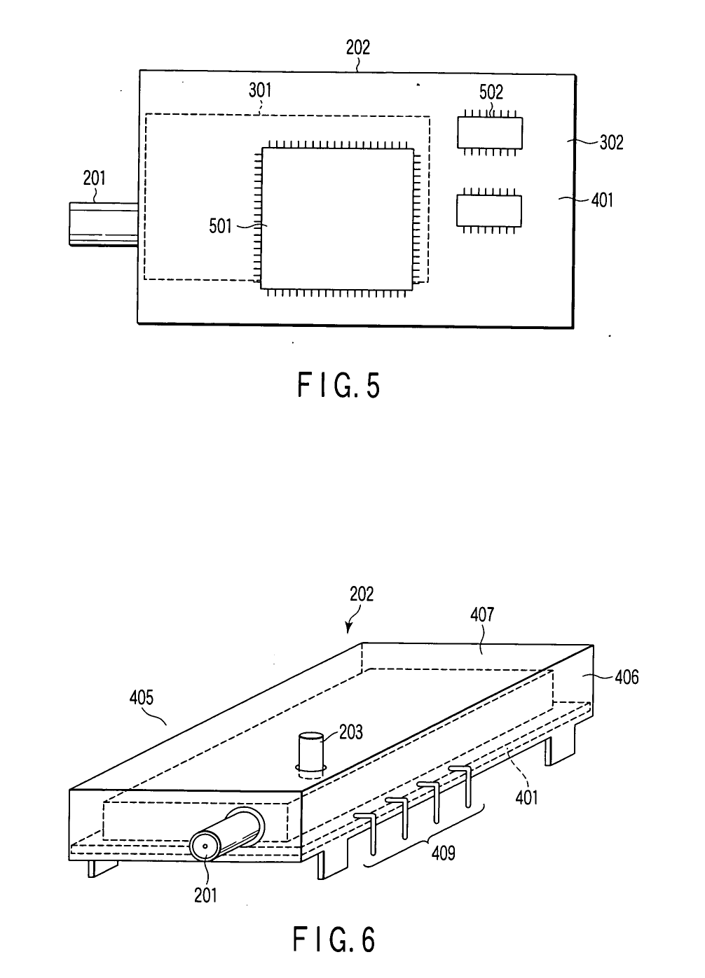

FIG. 5 shows a face opposite to a face on which the analog signal processing section 301 of the circuit board 401 is mounted. On this face, there are packaged: the transceiver LSI 312 which configures the above-described digital signal processing section 301; a semiconductor chip 501 on which the MAC section 313 and the microcomputer 314 or the like are integrally circuited; and an IC chip 502 which configures the Ethernet interface (I/F) 316.

FIG. 6 is a perspective view showing a state in which the cable modem module device 202 shown in FIG. 4 in an exploded manner has been assembled. The RF connector 203 protrudes from the first cover 407 of the shield case 405 in a direction orthogonal to a face of the circuit board 401.

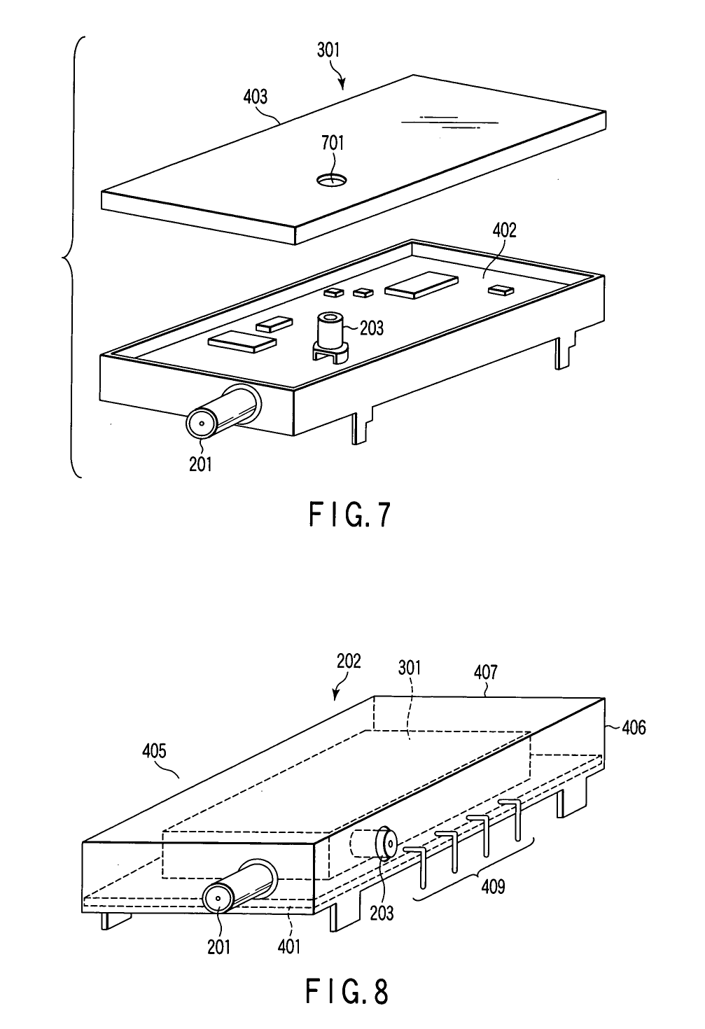

FIG. 7 shows a state in which only the analog signal processing section 301 is sampled and a shield case 403 of this section is released in the cable modem module device 202 shown in FIGS. 4 and 6, wherein the RF connector 203 is arranged on the circuit board 402; and the shield case 403 is assembled so that a distal end of the RF connector 203 protrudes from an opening section 701 provided in the shield case 403.

As has been described above, according to the cable modem module device 202 of the above-described embodiment, a signal is supplied to the tuner section 204 via the RF connector 203 provided on the circuit board 402 of the analog signal processing section 301. Thus, this module device is hardly affected by a digital signal, as compared with a case of supplying a signal to the tuner section 204 via a circuit board common to the digital signal processing section 302. A high quality signal can be led out to the tuner section 204 and a noise free video image and a voice can be obtained from the television receiver 106.

In addition, the RF connector 203 does not come into direct contact with the shield case 405 mechanically, thus making it possible to prevent interference subjected from the circuit board 401 of the digital signal processing section 302. Further, a downward receiving signal and a ground potential (reference potential) can be protected from a variety of interference transmitted to the shield case 405.

FIG. 8 shows a first modified example of the cable modem module device 202, wherein the RF connector 203 is provided so as to protrude in a direction parallel to a face of the circuit board 401.

According to the first modified example, in addition to an advantageous effect that the high quality signal can be led out to the tuner section 204, a distal end of the RF connector 203 does not protrude in a direction orthogonal to the face of the circuit board 401. Thus, when the cable modem module device 202 is incorporated as the cable modem device 104, its dimensional height can be reduced, and equipment can be downsized.

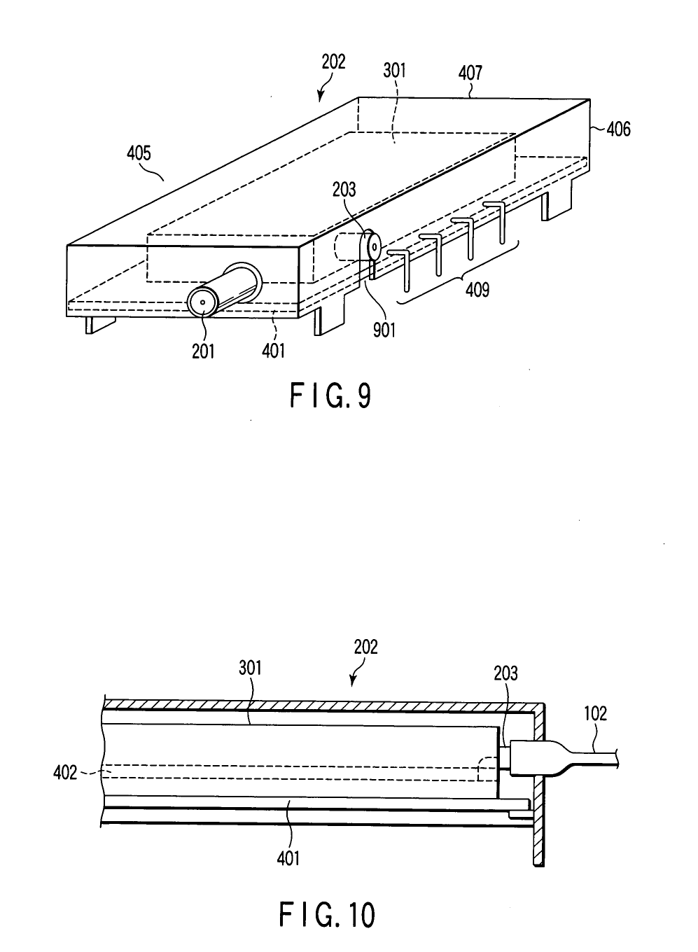

FIG. 9 shows a second modified example of the cable modem module device 202, wherein a cutout section 901 is provided in the metal case 406 of the shield case 405 to be associated with the RF coaxial connector 203.

According to the second modified example, in addition to the advantageous effect that the high quality signal can be led out to the tuner section 204, when the circuit board 401 having the analog signal processing section 301 packaged thereon is incorporated in the metal case 405, an assembling work can be carried out easily without the RF connector 203 being a obstacle.

FIG. 10 shows a third modified example of the cable modem module device 202, wherein the RF connector 203 is configured so as not to be protruded from the shield case 405.

According to the third embodiment, in addition to the advantageous effect that the high quality signal can be led out to the tuner section 204, the RF connector 203 does not protrude from the shield case 405. Thus, its dimensional shape can be reduced. As in the second modified example shown in FIG. 9, when the circuit board 401 having the analog signal processing section 301 packaged thereon is incorporated in the metal case 405, an assembling work can be easily carried out without the RF connector 203 being an obstacle. Further, there can be attained an advantageous effect caused by the RF connector 203 failing to come into contact with the shield case 405 mechanically.

FIG. 11 shows another use mode of the above-described cable modem device 104. In this example, the television receiver 106 comprises an Ethernet (registered trademark) connecting function, and is applied as an external device instead of a PC.

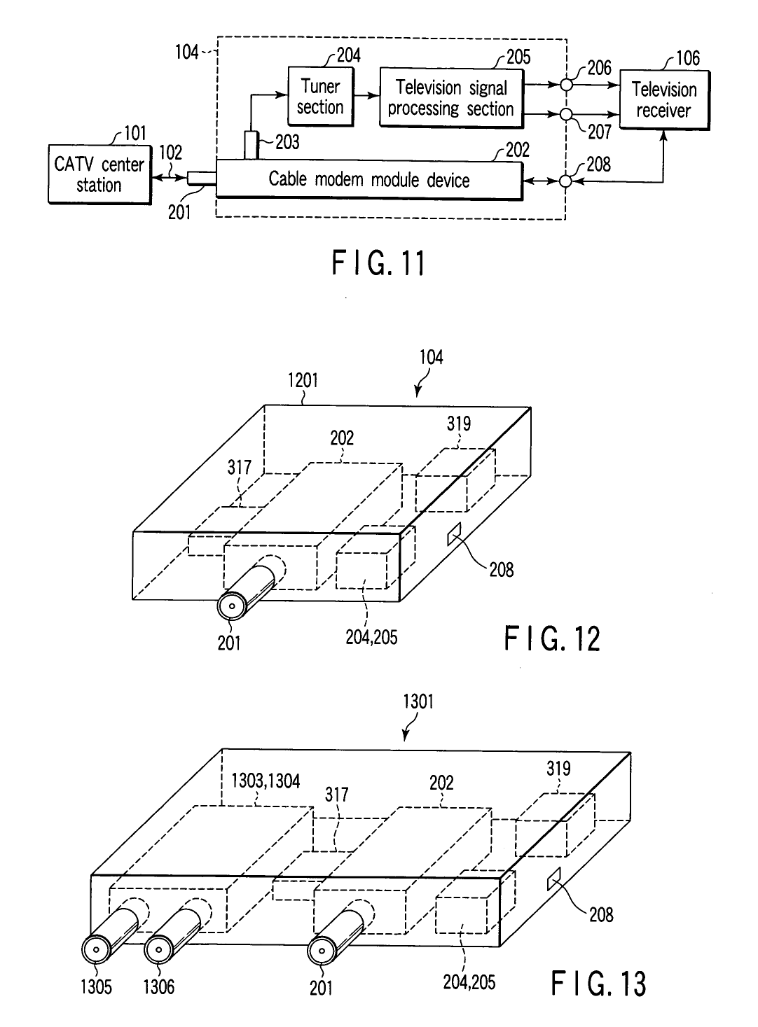

FIG. 12 shows a configuration of the cable modem device 104. This cable modem device 104 has the cable modem module device 202, the tuner section 204, and a television signal processing section 205 incorporated in a casing 1201. In addition, this modem device has the gain control section 317 and the power supply circuit 319 shown in FIG. 3. In addition, the Ethernet (registered trademark) terminal 208 for an external device to be connected is provided in the casing 1201.

FIG. 13 shows a configuration of a broadcast receiving device 1301 using the above-described cable modem device 104. That is, with respect to the cable modem device 104 shown in FIG. 12, a satellite broadcast receiving tuner section 1303 and a terrestrial broadcast receiving tuner section 1304 are incorporated in the casing 1301. Further, RF coaxial connectors 1305, 1306 which receive signals from an antenna for receiving these broadcasts are provided in the casing 1301.

According to this broadcast receiving device 1301, there can be provided a broadcast receiving device which enables receiving of a CATV broadcast, a satellite broadcast, and a terrestrial broadcast and an access to an information network net such as the Internet without being subjected to interference from the cable modem module device 202.

The present invention is not limited to the above-described embodiments. The present invention can be embodied by variously modifying constituent elements without departing from the spirit of the invention at a stage of carrying out the invention. For example, the cable modem module device may be configured to provide a CATV view and an access to the Internet by incorporating it in the television receiver.

In addition, a tuner section and a television signal processing section may be configured to provide a CATV view and an access to the Internet via a PC by incorporating them in the PC.

Further, although a broadcast receiving device has been disclosed as that formed in a set top box shape, of course, a device compatible with a display device can be configured.

In addition, a variety of inventions can be formed by properly combining a plurality of constituent elements disclosed in the above-described embodiments. For example, some of all the constituent elements presented in the embodiments may be eliminated. Further, constituent elements according to different embodiments may be properly combined with each other.

What is claimed is:

1. A cable modem module device comprising:
a first connector configured to be connected to a center station via a cable;
an analog signal processing section which has a first circuit board having packaged thereon a circuit configuring a transmission/receiving section configured to receive a high frequency signal supplied from the center station via the first connector and send out the high frequency signal to the center station via the first connector, a distributor section configured to distribute the high frequency signal received by the transmission/receiving section, and a frequency converter section configured to convert a frequency of the high frequency signal distributed by the distributor section, respectively;
a first shield section configured to shield the analog signal processing section in an electromagnetic manner;
a digital signal processing section which has a second circuit board having packaged thereon a circuit configuring transmission/receiving processing sections configured to carry out transmission and receiving processing between an external device and a modulation/demodulation processing section configured to process a signal outputted from the analog signal processing section and output the processed signal to the external device via the transmission/receiving processing sections and process the signal from the external device and output the processed signal to the transmission/receiving section to be lead out from the first connector, respectively, and having packaged thereon the analog signal processing section;
a second shield section configured to shield the digital signal processing section and the analog signal processing section shielded with the first shield section in an electromagnetic manner; and
a second connector configured to be provided on the first circuit board without being covered with the first shield section and the second shield section in order to lead out the high frequency signal distributed by the distributor section to the outside.

2. A cable modem module device according to claim 1, wherein the second connector is allocated in a direction parallel to a face of the second circuit board.

3. A cable modem module device according to claim 1, wherein the second connector does not come into contact with the second shield section in a mechanical manner.

4. A cable modem module device according to claim 1, wherein the second shield section has a cutout section formed at a position which corresponds to the second connector.

5. A cable modem module device according to claim 1, wherein the second connector does not protrude outwardly from the second shield section.

6. A cable modem device comprising:
a first connector configured to be connected to a center station via a cable;
an analog signal processing section which has a first circuit board having packaged thereon a circuit configuring a transmission/receiving section configured to receive a high frequency signal supplied from the center station via the first connector and send out the high frequency signal to the center station via the first connector, a distributor section configured to distribute the high frequency signal received by the transmission/receiving section, and a frequency converter section configured to convert a frequency of the high frequency signal distributed by the distributor section, respectively;
a first shield section configured to shield the analog signal processing section in an electromagnetic manner;
a digital signal processing section which has a second circuit board having packaged thereon a circuit configuring transmission/receiving processing sections configured to carry out transmission and receiving processing between an external device and a modulation/demodulation processing section configured to process a signal outputted from the analog signal processing section and output the processed signal to the external device via the transmission/receiving processing sections and process the signal from the external device and output the processed signal to the transmission/receiving section to be lead out from the first connector, respectively, and having packaged thereon the analog signal processing section;
a second shield section configured to shield the digital signal processing section and the analog signal processing section shielded with the first shield section in an electromagnetic manner;
a second connector configured to be provided on the first circuit board without being covered with the first shield section and second shield the section in order to lead out the high frequency signal distributed by the distributor section to the outside; and
a tuner section configured to receive the high frequency signal via the second connector.

7. A cable modem device according to claim 6, wherein the second connector is allocated in a direction parallel to a face of the second circuit board.

8. A cable modem device according to claim 6, wherein the second connector does not come into contact with the second shield section in a mechanical manner.

9. A cable modem device according to claim 6, wherein the second shield section has a cutout section formed at a position which corresponds to the second connector.

10. A cable modem device according to claim 6, wherein the second connector does not protrude outwardly from the second shield section.

11. A broadcast receiving device comprising:
a first connector configured to be connected to a center station via a cable;
an analog signal processing section which has a first circuit board having packaged thereon a circuit configuring a transmission/receiving section configured to receive a high frequency signal supplied from the center station via the first connector and send out the high frequency signal to the center station via the first connector, a distributor section configured to distribute the high frequency signal received by the transmission/receiving section, and a frequency converter section configured to convert a frequency of the high frequency signal distributed by the distributor section, respectively;
a first shield section configured to shield the analog signal processing section in an electromagnetic manner;
a digital signal processing section which has a second circuit board having packaged thereon a circuit configuring transmission/receiving processing sections configured to carry out transmission and receiving processing between an external device and a modulation/demodulation processing section configured to process a signal outputted from the analog signal processing section and output the processed signal to the external device via the transmission/receiving processing sections and process the signal from the external device and output the processed signal to the transmission/receiving section to be lead out from the first connector, respectively, and having packaged thereon the analog signal processing section;
a second shield section configured to shield the digital signal processing section and the analog signal processing section shielded with the first shield section in an electromagnetic manner;
a second connector configured to be provided on the first circuit board without being covered with the first shield section and the second shield section in order to lead out the high frequency signal distributed by the distributor section to the outside;
a first tuner section configured to receive the high frequency signal via the second connector;
a third connector configured to enable connection with a cable which transmits a television broadcast signal; and
a second tuner section configured to receive the television broadcast signal via the third connector.
